(19) United States
(12) Patent Application Publication
(10) Pub. No.: US 2026/0337885 A1
(43) Pub. Date: Oct. 29, 2026

(54) MULTILAYER PRODUCT AND METHOD FOR PRODUCING THE SAME

(71) Applicant: UPM-Kymmene Corporation, Helsinki (FI)

(72) Inventors: Janak SAPKOTA, Helsinki (FI); Salla HILTUNEN, Helsinki (FI); Matti RISTOLAINEN, Helsinki (FI); Teemu POHJALAINEN, Helsinki (FI); Pasi VIRTANEN, Helsinki (FI); Harri KOSONEN, Helsinki (FI); Sakari MODIG, Helsinki (FI)

(21) Appl. No.: 19/110,063

(22) PCT Filed: Sep. 4, 2023
(86) PCT No.: PCT/FI2023/050503

§ 371 Date: Mar. 8, 2025

(30) Foreign Application Priority Data
Sep. 13, 2022 (FI) 20225793

(51) Int. Cl. D21H 19/34; D21H 19/82; D21H 21/52; D21H 27/10; D21H 27/28

(52) U.S. Cl. CPC D21H 19/34; D21H 19/824; D21H 21/52; D21H 27/10; D21H 27/28

(57) ABSTRACT

A multilayer product is disclosed. The multi-layer product may comprise a cellulose fiber-based base layer and a barrier layer. The barrier layer may comprise at least 10 % (w/w) of hydrolysed cellulose fibers. The multilayer product may further comprise a cellulosic filmic layer.

### TECHNICAL FIELD

The present disclosure relates to a multilayer product and a method for producing the multilayer product.

### BACKGROUND

The demand for packaging materials is growing significantly. Packaging solutions that are renewable, recyclable as well as biodegradable are in need.

Cellulose, for example in the form of cellulose fibers or pulp, is a renewable and biodegradable material well suited for packaging solutions. However, often plastic materials or other less environmentally friendly materials may be required e.g. as coatings to impart barrier properties to packaging materials formed mainly from cellulose. Such packaging materials are not fully biodegradable, and their recycling may be complicated.

### SUMMARY

A multilayer product is disclosed. The multi-layer product may comprise a cellulose fiber-based base layer and a barrier layer. The barrier layer may comprise at least 10% (w/w) of hydrolysed cellulose fibers. The multilayer product may further comprise a cellulosic filmic layer.

### BRIEF DESCRIPTION OF THE DRAWINGS

The accompanying drawings, which are included to provide a further understanding of the embodiments and constitute a part of this specification, illustrate various embodiments. In the drawings:

FIG. 1A illustrates an embodiment of the multilayer product 1 in cross-sectional view;

FIG. 1B describes another embodiment of the multilayer product;

FIG. 1C describes another embodiment of the multilayer product;

FIG. 1D describes yet another embodiment of the multilayer product;

FIG. 2A shows the oxygen transmission rate of a cellulosic film;

FIG. 2B shows the grease permeability of the cellulosic film;

FIG. 3 illustrates packaging material produced by compression molding a fiber body with a cellulosic filmic layer;

FIG. 4 illustrates packaging material produced by calendering a fiber body with cellulosic filmic layer;

FIG. 5A illustrates apparent bulk density values for specific fiber mixtures;

FIG. 5B shows tensile index values for specific fiber mixtures;

FIG. 5C shows strain at break values for specific fiber mixtures; and

FIG. 6 shows air permeance measurements of multilayer structures.

### DETAILED DESCRIPTION

A multilayer product is disclosed.

The multilayer product may comprise a cellulose fiber-based base layer and a barrier layer. The barrier layer may comprise at least 10% (w/w) of hydrolysed cellulose fibers. The multilayer product may further comprise a cellulosic filmic layer.

The hydrolysed cellulose fibers are a moldable material, and when the material of the barrier layer comprising the hydrolysed cellulose fibers is densified e.g. by compressing, a material layer with low porosity may be obtained. The hydrolysed cellulose fibers may have surface-closing properties. For example, with calendering, a very dense structure may be obtained from the material of the barrier layer. Such a layer may have barrier properties. For example, it may be a gas (oxygen) barrier and/or an grease barrier layer, such as an oil barrier layer.

The base layer may function as a support layer, i.e. it may provide mechanical strength to the multi-layer product.

The base layer and the barrier layer may both be formed of cellulose-based materials. In other words, the barrier layer may also be cellulose fiber-based. The cellulosic filmic layer may also be formed of cellulose-based materials. Thus the entire multilayer product may be formed, or mainly formed, of cellulose-based materials.

The composition of the base layer as well as of the barrier layer may be selected such that the strength and, on the other hand, the density of the multilayer product may be optimized as desired. The composition of the barrier layer may also be selected such that desired barrier properties are obtained.

Further, the properties of the multilayer product may be adjusted by including a cellulosic filmic layer.

Such a multilayer product does not necessarily need e.g. a plastic coating or other layers or coatings that are not cellulose-based. For example, barrier properties have traditionally been achieved using fluorochemicals, which are harmful e.g. to the environment and the use of which may be phased out in the future. Obviating or reducing the need to use additional layers or coatings to achieve barrier properties may be highly useful e.g. for environmental reasons. The multilayer product according to one or more embodiments described in this specification may be biodegradable and relatively easily recyclable with existing processes. For example, up to 50% of the cellulose fibers in the multilayer product may be recoverable in a recycling process. The multilayer product may be compostable. The multilayer product may be burned and may burn relatively cleanly.

The barrier layer may cover the base layer at least partially, or the base layer may cover the barrier layer at least partially.

The barrier layer and the base layer may be attached to each other, either directly or via one or more additional layers or a medium such as an adhesive. The barrier layer and the base layer may be at least partially superimposed, or the barrier layer and the base layer may be fully superimposed.

The barrier layer may or may not be the outermost layer of the multilayer product. Depending on the embodiment, both sides of the barrier layer may be covered by other layers.

The multilayer product may comprise at least two layers, e.g. two, three or more layers.

The multilayer product may comprise at least one barrier layer.

The multilayer product may comprise at least one base layer.

The multilayer product may comprise at least one barrier layer and at least one base layer.

The multilayer product may further comprise additional layers. For example, the multilayer product may comprise a middle layer (or at least one middle layer) between the base layer and the barrier layer. Such a middle layer may also be cellulose fiber-based. However, its composition may be different from the base layer and/or the barrier layer. The multilayer product may comprise two or more base layers and/or two or more barrier layers.

The multilayer product may comprise a base layer and two barrier layers, the barrier layers arranged at opposite sides of the base layer.

The multilayer product may comprise a barrier layer and two base layers, the base layers arranged at opposite sides of the barrier layer.

The barrier layer may be densified and/or compressed. In other words, the barrier layer may be a densified and/or compressed layer.

The base layer may be densified and/or compressed. In other words, the base layer may be a densified and/or compressed layer.

Both the barrier layer and the base layer may be densified and/or compressed.

The densification may be performed e.g. by wet or dry calendering. Wet calendering may improve the densifying even further.

However, compression or densification may not always be necessary to achieve desired barrier properties. For example, the barrier layer may be formed by spraying the material of the barrier layer onto the base layer (or, in some embodiments, onto another additional layer). By way of another example, the barrier layer and the base layer (and any additional layers, if present) may be formed e.g. in a two-layer or multilayer headbox of a paper machine or board machine.

The densification and/or compression may provide e.g. a certain oxygen transmission rate to the multilayer product. The densification and/or compression may provide e.g. a certain smoothness to the barrier layer.

The multilayer product may be a moldable or molded product.

The moldable multilayer product may be e.g. a sheet or a flat structure. Such a moldable multilayer product may be molded to a final form having a desired shape. Various methods for molding the multilayer product may be available.

The molded multilayer product may be e.g. a container or a receptacle, such as a cup or a plate. However, the shape of the molded multilayer product is not particularly limited.

The multilayer product may be flexible, or a flexible multilayer product. The multilayer product may alternatively be rigid, or a rigid multilayer product. The multilayer product may be e.g. a packaging material, a packaging paper, a wrapping paper, a protective paper, a packaging board, a packaging 3D material, a decorative paper, an envelope, or a release liner.

The multilayer product may be mainly formed of cellulose-based materials. However, the presence of minor amounts of non-cellulose-based materials is not necessarily excluded in such a multilayer product. For example, the multilayer product that is mainly formed of cellulose-based materials may contain at least one of e.g. an adhesive, such as glue, an additive, a color or an ink, that is not cellulose-based.

In some embodiments, the multilayer product may be formed entirely of cellulose-based materials.

In the context of this specification, the term “mainly formed of cellulose-based materials” may refer to a multilayer product, at least 85% (w/w), or at least 95% (w/w), or at least 98% (w/w), or at least 99% (w/w), or 100% (w/w) of the material of which is cellulose-based.

The multilayer product may be biodegradable. The multilayer product may be biodegradable as determined by the standard OECD for testing of chemicals 301 F.

The term “biodegradable” may, at least in some embodiments, refer to readily biodegradable as determined by the standard OECD for testing of chemicals 301 F (Manometric respiratory test). The readily biodegradable multilayer product may be a multilayer product for which at least 60% biodegradability is reached within 28 days as determined by the standard OECD for testing of chemicals 301 F.

The multilayer product may be recyclable.

The base layer may comprise a reinforcing component. The reinforcing component may comprise or be e.g. cellulose fibers. Such cellulose fibers may be such that they may impart reinforcing properties to the multilayer product. For example, they may be unmodified and/or non-hydrolysed. In other words, the reinforcing component of the base layer may be cellulose fibers, for example unmodified and/or non-hydrolysed. The CED viscosity of the cellulose fibers of the base layer may be greater than 500 ml/g, e.g. in the range of about 500 to 3000 ml/g. In some embodiments, the CED viscosity of the cellulose fibers of the base layer may be e.g. in the range of 800 to 1200 ml/g, or in the range of 900 to 1100 ml/g.

The fibers of the cellulose fibers (including hydrolysed or non-hydrolysed cellulose fibers of the barrier layer, the base layer, and/or of any additional layer comprising cellulose fibers, or of the reinforcing component) may be natural fibers, such as lignocellulo-sic fibers, cellulose fibers, cellulose fiber derivatives, wood derivatives or any combinations or mixtures thereof. The fibers in the cellulose fibers may be natural origin fibers, such as modified natural origin fibers, and/or cellulose-based fibers. The fibers in the cellulose fibers may be virgin, recycled or secondary natural fibers, or any mixture or combination thereof. The cellulose fibers may be e.g. staple fibers. The cellulose fibers may be fibers derived from e.g. cotton or cotton linter. The cellulose fibers may comprise or be e.g. pulp. The pulp may comprise or be e.g. wood pulp (such as hardwood and/or softwood pulp), non-wood pulp, and/or agropulp. The pulp may be chemical pulp, such as kraft pulp, soda, sulphate, or organosolv pulp. The pulp may be mechanical & thermal pulp (TMP), mechanical pulp (groundwood (GW), pressure ground wood pulp (PGW), refiner mechanical pulp (RMP) ), and/or chemi-thermomechanical pulp (CTMP). The pulp may, additionally or alternatively, be never dried pulp, such as never dried kraft pulp. The cellulose fibers or the pulp may comprise or be recycled fibers. The fibers in the cellulose fibers may comprise or be at least one of wood pulp, non-wood pulp, staple fibers, recycled fibers, or any mixture or combination thereof. In some embodiments, the fibers in the cellulose fibers may not comprise man-made fibers and/or oil-based fibers. Staple fibers with a desired length may be combined with other types of reinforcing components, such as other types of cellulose fibers.

In the context of this specification, the term “non-hydrolyzed cellulose fibers” may refer to cellulose fibers that are not purposefully chemically hydrolysed to a significant extent. However, the non-hydrolyzed cellulose fibers may be e.g. chemical pulp, such as Kraft pulp, and may be e.g. bleached during the production process of the chemical pulp. Although e.g. the Kraft pulping process may lead to minor hydrolysis of the cellulose fibers, chemical pulp may still be considered to be or contain non-hydrolyzed cellulose fibers.

The reinforcing component, or the other cellulose fibers, may be or comprise chemical pulp, such as Kraft pulp, sulphate pulp, and/or organosolv pulp; and/or staple fibers.

The other (e.g. cellulose fibers of the reinforcing component) cellulose fibers may comprise or be natural fibers having a CED viscosity in the range of 500-3000 ml/g and/or man-made cellulosic fibers. The man-made cellulosic fibers may, at least in some embodiments, have a lower CED viscosity.

In the context of the present disclosure, the term “hydrolysed cellulose fibers” may be understood as referring to cellulose fibers that have been subjected to a treatment which has hydrolysed the cellulose chains of the cellulose fibers at least partially, for example as compared to comparable, non-hydrolysed cellulose fibers. Thus the average length of the cellulose chains of the hydrolysed cellulose fibers may be smaller than the average length of the cellulose chains of comparable cellulose fibers that are unhydrolysed. Certain properties, such as CED viscosity, of the cellulose fibers may be affected by the hydrolysis. The hydrolysed cellulose fibers may be obtainable or obtained e.g. by a 2-3-h enzymatic hydrolysis of the cellulose fibers utilizing cellulolytic enzymes. The hydrolysed cellulose fibers may be or comprise e.g. hydrolysed pulp. In this context, the pulp of the hydrolysed pulp may be any pulp described in this specification.

The hydrolysed cellulose fibers may have a CED viscosity in the range of 50 to 500 ml/g, or 50 to 400 ml/g. In some embodiments, the hydrolysed cellulose fibers may have a CED viscosity in the range of 120 to 300 ml/g, or in the range of 140 to 200 ml/g.

The term “CED viscosity” may be understood as referring to limiting viscosity number in cupri-ethylenediamine (CED) solution. The CED viscosity may be measured e.g. according to the standard ISO 5351:2010.

The hydrolysed cellulose fibers may have a degree of polymerization (DP) in the range of about 100 to 700, or in the range of about 120 to 300. The degree of polymerization may be measured e. g. using the standard ISO 5351:2010 (en). The degree of polymerization (DP) may be estimated from the CED viscosity value obtained according to the standard according to:

DP=0.75[μ]^{1/0.905}, where [μ] is the CED viscosity value.

The hydrolysed cellulose fibers may, in some embodiments, be obtainable by a pretreatment or modification, for example a with a surface modification, saponification of cellulose esters, or phosphorylation. The hydrolysed cellulose fibers may have traces of processes causing e.g. changes in the surface chemistry. The barrier layer may be formed of a material comprising at least 10% (w/w) of hydrolysed cellulose fibers. The barrier layer, i.e. the material of the barrier layer, may comprise e. g. at least 20% (w/w), or at least 30% (w/w), or at least 40% (w/w), or at least 50% (w/w), at least 60% (w/w), or at least 70% (w/w), or at least 80% (w/w), or 100% (w/w) of the hydrolysed cellulose fibers. The barrier layer, i.e. the material of the barrier layer, may be a mixture comprising the hydrolysed cellulose fibers and other (i.e. cellulose fibers of the reinforcing component and/or non-hydrolysed) cellulose fibers. The other cellulose fibers may be any cellulose fibers described in this specification, in particular any cellulose fibers described as the reinforcing component. The properties, such as degree of polymerization and/or CED viscosity of the hydrolysed and the other cellulose fibers may differ from each other. The proportions of the hydrolysed cellulose fibers and the reinforcing component, such as the other cellulose fibers, and optionally of other components, may be selected such that the properties of the barrier layer are as desired. For example, an increase in the proportion of the hydrolysed cellulose fibers may increase the density of the barrier layer, which in turn may decrease the permissibility to e.g. grease and/or oxygen. The proportion of the hydrolyzed cellulose fibers may thus be selected so as to achieve a desired density, desired barrier properties and/or desired smoothness. The other cellulose fibers, such as cellulose fibers of the reinforcing component (if present) may be provided as a desired proportion e.g. to provide a desired strength and/or other properties to the barrier layer.

The barrier layer comprising the hydrolysed cellulose fibers may be densified or compressed such that it has a desired density. Such a barrier layer may have improved barrier properties and smoothness.

The proportion of at least 10% (w/w) of the hydrolysed cellulose fibers may be understood as the dry weight of the hydrolysed cellulose fibers based on the total dry weight of the mixture from which the barrier layer is formed and/or the total dry weight of the layer. The barrier layer, i.e. the material of the barrier layer, may comprise about 10 to 90% (w/w) of the hydrolysed cellulose fibers, and about 10 to 90% (w/w) of other cellulose fibers.

The barrier layer, i.e. the material of the barrier layer, may comprise about 60 to 80% (w/w) of the hydrolysed cellulose fibers, and about 20 to 40% (w/w) of other cellulose fibers.

The weight ratio of the hydrolysed cellulose fibers to the other cellulose fibers may be in the range of about 30:70 to about 10:90, or in the range of about 40:60 to about 20:80.

The multilayer product may further comprise a surface chemical for providing barrier properties. The surface chemical may be applied to the multilayer product. The surface chemical for providing barrier properties may comprise or be e.g. starch, a wax, a fatty acid, an alkyl ketene dimer, an alkyl succinic anhydride, a thermoplastic component, or any combination or mixture thereof. The surface chemical may or may not react with the cellulose of the cellulose fibers chemically; this may depend on its chemical properties. The surface chemical may physically attach to the cellulose. It may e.g. impregnate the barrier layer and/or the base layer and provide desired physical properties to the multilayer product.

The multilayer product may further comprise a coating covering the barrier layer and/or the base layer.

The coating may be the outermost layer of the multilayer product.

The coating may be or be applied as e.g. a hot melt coating, a dip coating, or a carton coating. Such a coating, e.g. a hot melt coating, may improve the heat-sealing properties of the multilayer product.

The multilayer product may further comprise a cellulosic filmic layer. In other words, the multilayer product may further comprise a coating, which is a cellulosic filmic layer.

The cellulosic filmic layer may be formed by coagulating alkaline cellulose dope. The cellulosic filmic layer may cover the barrier layer. The cellulosic filmic layer may cover the barrier layer, or any other layer, such that the cellulosic filmic layer may be the outermost layer of the multilayer product. The cellulosic filmic layer may improve the oxygen and/or grease barrier properties of the multilayer product. Such an embodiment may not necessarily be moldable, however. When the coating is a cellulosic filmic layer, it may also be biodegradable. Thus the entire multilayer product may be cellulose-based and optionally biodegradable, as opposed e.g. to a multilayer product comprising a plastic coating.

In the context of this specification, the term “alkaline cellulose dope” may be understood as a solution comprising cellulose solubilized in an alkaline solution, often in a cold alkaline solution. For example, the alkaline cellulose dope may be a cellulose spinning solution (i.e. an alkaline cellulose spinning solution) or a cellulose solution (i.e. alkaline cellulose solution) for extrusion, spinning, electrospinning, molding, casting, film forming, film extrusion, cellulose pearl production, coating, spraying and/or 3D printing. In other words, it may refer to cellulosic material in alkaline solution suitable for use e.g. in spinning filaments, staple fibers, film making, cellulose pearl production, and various other purposes. The cellulose alkaline cellulose dope may be coagulated in suitable conditions into solid cellulose, for example into type II cellulose.

Providing the cold alkaline solution may typically comprise mixing and/or dissolving an alkaline agent, such as NaOH, and optionally a dissolution or stabilizing agent, for example a zinc compound, such as ZnO, with water. They may be mixed at conditions suitable for dissolving the components in water, for example at an elevated temperature and such that the alkaline agent, such as NaOH, is added at a concentration of at least 40 (w/w). The elevated temperature may be e.g. a temperature of at least 60° C. The resulting alkaline solution may then be diluted. The alkaline agent in the (cold) alkaline solution may comprise or be e.g. NaOH, LiOH, KOH, and/or any mixture or combination thereof.

The cellulosic filmic layer may be applied e.g. by calendering. This may be done e. g. such that a cellulosic film is prepared, for example by extruding and coagulating an alkaline cellulose dope, and preparing the multilayer product separately. The multilayer product and the cellulosic film may be combined and calendered, such that the cellulosic film is attached to the multilayer product and forms the cellulosic filmic layer.

The cellulosic filmic layer may, alternatively, be formed by surface treatment. The product may be surface treated e.g. with a hydroxide, such as NaOH, such that cellulose fibers at the surface f the multilayer product are at least partially solubilized and subsequently coagulated, thereby forming a cellulosic filmic layer. The cellulosic filmic layer formed by the surface treatment may be similar to a cellulosic filmic layer prepared e.g. by coagulating an alkaline cellulose dope.

The multilayer product may further comprise an adhesive layer between the base layer and the barrier layer. The multilayer product may comprise an adhesive layer (or a further adhesive layer) between one or more other layers. The adhesive layer may attach the base layer and the barrier layer, and/or any other layer(s) (depending on the embodiment and the presence and arrangement of the layers), to each other. The adhesive may be e.g. a bio-based and/or biodegradable adhesive, such as a bio-based and/or biodegradable glue.

The multilayer product may further comprise an ink and/or lacquer layer. The ink and/or lacquer layer may be formed e.g. by printing ink on or by lacquering a surface of the multilayer product.

The base layer may formed of a densified cellulose fiber mixture.

The base layer may comprise at least 50% (w/w) of Kraft pulp and/or mechanical pulp and 50% (w/w) or less of hydrolysed cellulose fibers.

The base layer, i.e. the material of the base layer, may comprise about 50 to 90% (w/w) of Kraft pulp and/or mechanical pulp, and about 10 to 50% (w/w) of hydrolysed cellulose fibers.

The base layer, i.e. the material of the base layer, may comprise about 60 to 80% (w/w) of Kraft pulp and/or mechanical pulp, and about 20 to 40% (w/w) of hydrolysed cellulose fibers.

The base layer may comprise 100% of non-hydrolysed cellulose fibers, e.g. Kraft pulp and/or mechanical pulp.

The weight ratio of hydrolysed cellulose fibers to non-hydrolysed cellulose fibers in the base layer may be in the range of about 10:90 to about 50:50.

The weight ratio of hydrolysed cellulose fibers to non-hydrolysed cellulose fibers in the base layer may be in the range of about 20:80 to about 40:60.

The base layer may have a weight e.g. of at least 20 gsm, or in the range of 20-800 gsm, or in the range of 40-800 gsm (grams per square meter).

The barrier layer may have a thickness of 300 um or less, or in the range of 1-200 μm, or in the range of 10-100 μm, or in the range of 10-40 μm.

The base layer and the barrier layer may be mechanically separable from each other. Such separation may be useful e.g. for recycling purposes. The layers may be mechanically separable e.g. depending on the manufacturing method used for preparing the multilayer product and/or on the presence and type of additives included in the multilayer product. The separability of the base layer and the barrier layer may depend e.g. on the presence and composition of an adhesive layer arranged between the base layer and the barrier layer. The base layer and the barrier layer may be separated e.g. in a pulper, in which they may be separated by suspending them in water so as to form particles, and subsequently separating the particles based on density. The multilayer product may, in some embodiments, not comprise any plastic and/or metal. The multilayer product may, in some embodiments, not comprise inorganic materials, such as pigments.

The multilayer product may have an oxygen transmission rate of 100 cm³/(m².day) or less. The multilayer product may have an oxygen transmission rate of 10 cm³/(m².day) or less, or of 1 cm³/(m². day) or less The oxygen transmission rate may be measured at 23° C. and 50% relative humidity. The oxygen transmission rate may be measured using a MOCON OX-TRAN@ instrument. The instrument design operations may be consistent with the ASTM D 3985 standard. The oxygen transmission rate may, in some embodiments, be measured according to one of the standards ASTM D3985, ASTM F1927, or ISO 15105-2, using a Mocon Ox-Tran 2/21 MH instrument. In an embodiment, the oxygen transmission rate is measured day at 23° C. and 0% relative humidity with 100% Of using a MOCON OX-TRAN instrument in accordance with the ASTM D 3985 standard.

The multilayer product may have an air permeance Bendtsen (i.e. air permeance measured using a Bendtsen tester) of 100 ml/min or less. The multilayer product may have an air permeance Bendtsen of 20 ml/min or less, or 5 ml/min or less. The air permeance Bendtsen values may be measured e.g. according to the standard ISO 5636-3.

The composition of the multilayer product, such as the presence of absence of a surface chemical, or densification and/or compression, may have significant effects on the water vapor permeability and oil permeability (as measured e.g. by heptane vapor transmission rate). Thus the values of such parameters may vary significantly for multilayer products according to various embodiments described herein.

The water vapor permeability of the multilayer product may be e.g. 1000 g/(m².day) or less, or 100 g/(m².day) or less, or 20 g/(m².day) or less. The water vapor permeability may be determined at 23° C. and 50% relative humidity.

The multilayer product may have a heptane vapor transmission rate of e.g. 50 g/(m².day) or less, or 20 g/(m².day) or less, or 10 g/(m².day) or less. The heptane vapor transmission rate may be determined at 23° C. and 50% relative humidity.

The multilayer product may be semi-transparent and/or translucent. This may depend e.g. on the composition of the base layer. The base layer may be densified to such an extent that it is translucent and/or semi-transparent.

The light transmittance of the product may be in the range of 0 to 70%, or in the range of 1 to 70% or of 20 to 70%. The light transmittance may be understood as referring to visible light transmittance. The light transmittance may be measured e.g. with an optical profiler.

A method for producing the multilayer product according to one or more embodiments described in this specification is also disclosed.

The method may comprise forming the base layer and the barrier layer, and forming the multilayer product therefrom, for example by attaching the base layer and the barrier layer (and optionally one or more additional layers) to each other.

The method may comprise providing the material of the barrier layer and the material of the base layer; forming the base layer and the barrier layer, and forming the multilayer product therefrom. The materials and compositions of the materials of the barrier layer and of the base layer may be according to one or more embodiments described in this specification.

The method may comprise forming the base layer and the barrier layer simultaneously, thereby forming the multilayer product. The base layer and the barrier layer may be formed simultaneously e.g. in a two-layer or multilayer headbox of a paper machine or board machine. If desired, additional layers may be formed simultaneously, or they may be attached to the multilayer product. The resulting web forming both the base layer and the barrier layer (and optionally additional layers) may be densified or compressed, for example by calendering. The densifying may be performed e.g. by wet or dry calendering. Wet calendering may improve the densifying even further.

In some embodiments, the base layer may be formed; the material of the barrier layer comprising the hydrolysed cellulose fibers may be formed into a web, and the web may be calendered, such that the barrier layer is formed; and the barrier layer may be applied on the base layer, optionally such that an adhesive layer is applied between the base layer and the barrier layer.

The web (which may form the barrier layer and/or both the base layer and the barrier layer) may be calendered. It may be calendered e.g. using a nip pressure of 3-350 kN/m.

In some embodiments, the barrier layer may be formed by spraying the material of the barrier layer onto the base layer (or, in some embodiments, onto another additional layer).

The method may further comprise adding a coating, such as a cellulosic filmic layer, to the multilayer product.

The cellulosic filmic layer may be applied by calendering. This may be done e.g. such that a cellulosic film is prepared, for example by extruding and coagulating an alkaline cellulose dope, and preparing the multilayer product separately. The multilayer product and the cellulosic film may be combined and calendered, such that the cellulosic film is attached to the multilayer product and forms the cellulosic filmic layer.

The cellulosic filmic layer may be added by coagulating alkaline cellulose dope on the multilayer product.

The method may further comprise forming a cellulosic filmic layer to the multilayer product by surface treatment. The multilayer product may be surface treated e.g. with a hydroxide, such as NaOH, such that cellulose fibers at the surface of the multilayer product are at least partially solubilized and subsequently coagulated, thereby forming a cellulosic filmic layer. The cellulosic filmic layer formed by the surface treatment may be similar to a cellulosic filmic layer prepared e.g. by coagulating an alkaline cellulose dope.

The method may further comprise molding the product. The product may be molded e. g. from a dry web.

### EXAMPLES

Reference will now be made in detail to various embodiments, exampled of which are illustrated in the accompanying drawings.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

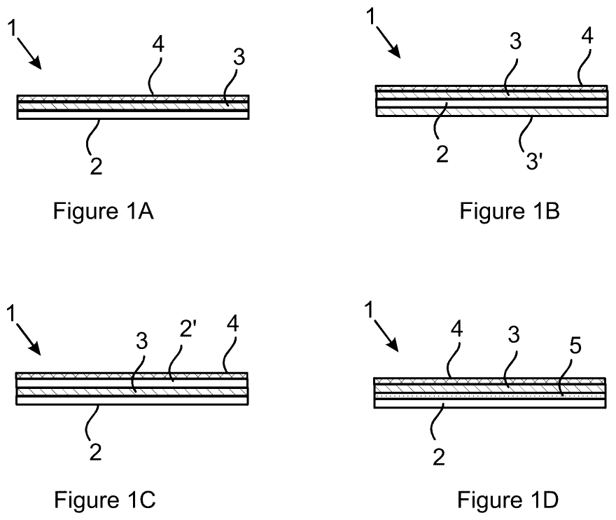

FIG. 1A describes an embodiment of the multilayer product 1 in cross-sectional view. The multilayer product 1 comprises a cellulose fiber-based base layer 2 and a barrier layer 3. The barrier layer 3 covers the base layer 2 at least partially, or as shown in FIG. 1A, entirely. The multilayer product 1 further comprises a coating 4. The coating 4 may be a cellulosic filmic layer. The coating or cellulosic filmic layer 4 is arranged on the barrier layer 3. It covers the barrier layer 3 at least partially, or as shown in FIG. 1A, entirely. However, as a skilled person will understand, the coating 4 could alternatively or additionally be arranged on the base layer 2.

FIG. 1B describes another embodiment of the multilayer product 1. The multilayer product 1 is similar to the one depicted in FIG. 1A, except that the multilayer product 1 comprises four layers: a base layer 2, two barrier layers 3 and 3′, and a cellulosic filmic layer 4. The barrier layers 3 and 3′ are arranged on opposite sides of the base layer 2. The cellulosic filmic layer 4 is the outermost layer. It is arranged on one of the barrier layers 3.

FIG. 1C describes yet another embodiment of the multilayer product 1. The multilayer product 1 is similar to the one depicted in FIG. 1B, except that the multilayer product 1 comprises four layers: two base layers 2 and 2′, a barrier layer 3, and a cellulosic filmic layer 4. The base layers 2 and 2′ are arranged on opposite sides of the barrier layer 3. The cellulosic filmic layer 4 is the outermost layer. It is arranged on one of the base layers 4.

FIG. 1D describes yet another embodiment of the multilayer product 1. The multilayer product 1 is similar to the one depicted in FIG. 1A, except that the multilayer product 1 further comprises an adhesive layer 5 between the base layer 2 and the barrier layer 3. The adhesive layer 5, extending between the base layer 2 and the barrier layer 3, may attach the base layer 2 and the barrier layer 3 to each other. The adhesive in the adhesive layer 5 may be e.g. any adhesive described in this specification. As a skilled person will understand, the adhesive layer 5 could also be included e. g. in multilayer products as shown in any one of FIGS. 1A to 1C.

The exemplary embodiments shown in FIGS. 1A to 1D are flat or sheet-like, and may be moldable or molded into a desired shape.

### Example 1

The oxygen transmission rate (OTR) and grease permeability of a cellulosic film were measured. Cellulosic films were prepared by regenerating alkaline cellulose dope in citric acid, with or without plasticizer, and dried the produced films at 180° C. and 410 kPa for 3 min. Oxygen transmission rate and fat permeability of the films were measured.

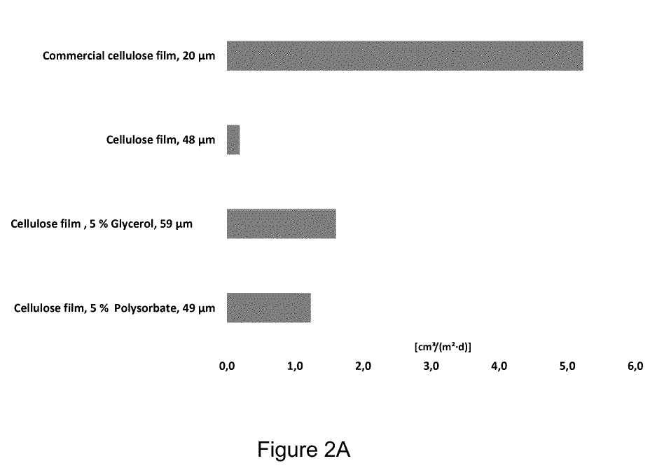

Oxygen transmission rate of the cellulosic film at 23° C. and 50% relative humidity is shown in FIG. 2A and grease permeability at 40° C. in FIG. 2B.

### Example 2

The coating of the fiber composition (fiber body, i.e. a base layer) with a cellulosic filmic layer was assessed. The cellulosic filmic layer was applied directly by sandwiching the structures in a compression molding process. Initially the base layer and filmic layer were conditioned at appropriate humidity chamber and compression molding was done at 80° C. with 410 kp pressure for 20 mins or 95° C. with 650 kp pressure for 20 min. The pre-conditioning of the base layer and the film and application pressure and temperature can be adjusted depending on the needs.

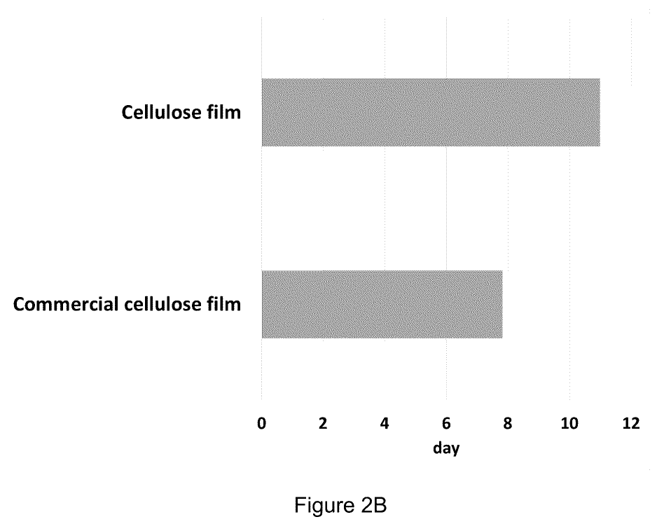

Packaging material produced by compression molding a base layer with a cellulosic filmic layer is shown in FIG. 3.

### Example 3

The coating of a fiber composition (fiber body, i. e. a base layer) with cellulosic film, applied by calendering process, was assessed. Initially the base layer and/or film was/were conditioned at appropriate humidity chamber and calendaring was done at 80° C. with 500 kp pressure or 100° C. with 6000 kp pressure. The pre-conditioning of the base layer and the film and application pressure and temperature can be adjusted depending on the needs.

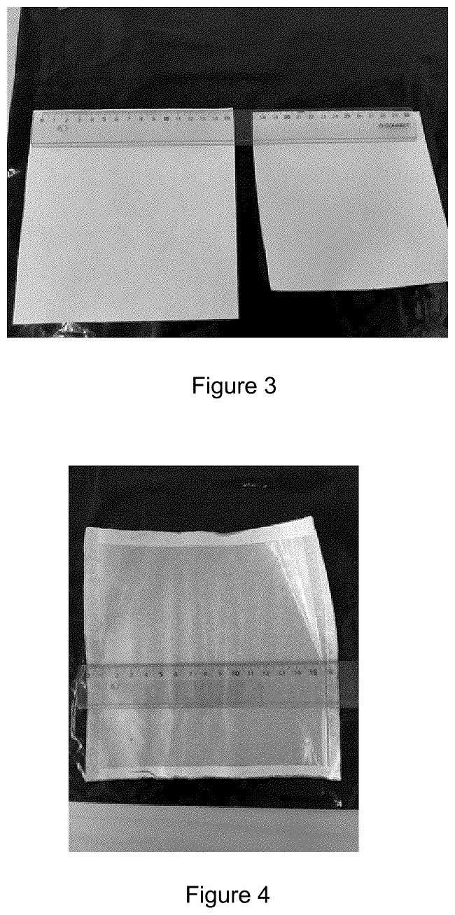

FIG. 4 illustrates packaging material produced by calendering a base layer with cellulosic film.

### Example 4

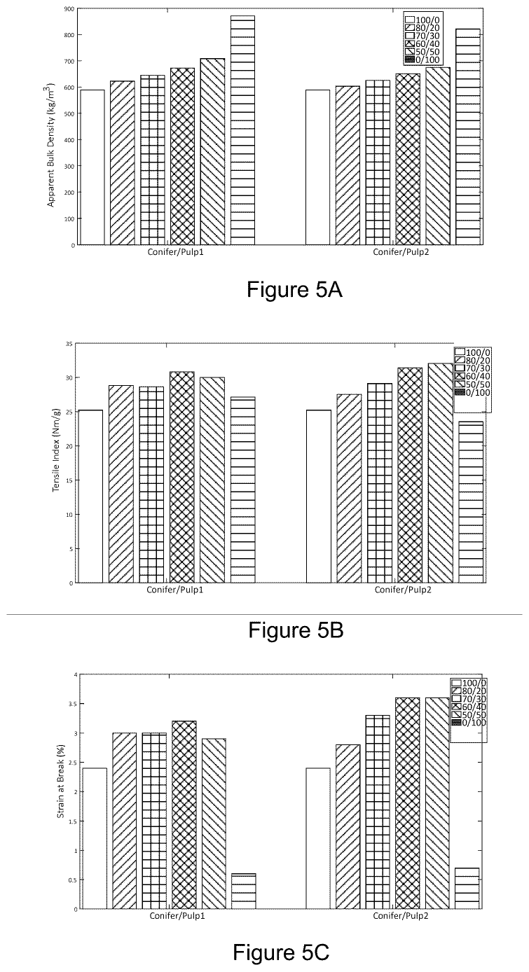

The physical and mechanical properties of a mixture comprising kraft conifer pulp fibers with hydrolyzed kraft conifer pulp fibers with different CED viscosities were assessed. Pulp 1 refers to hydrolyzed kraft conifer pulp fiber with CED of 166 ml/g and Pulp 2 refers to hydrolyzed kraft conifer fiber with a CED viscosity of 200 ml/g. Formulation x: y represents the dry weight fiber mixture with kraft conifer pulp fibers: Pulp 1 or Pulp 2. For example, 60:40 represents to the formulation having 60% of kraft conifer pulp fibers with 40% of Pulp 1 or Pulp 2. The physical-mechanical properties of the formulations are shown in FIGS. 5A, 5B and 5C, respectively.

FIG. 5A illustrates apparent bulk density values for specific fiber mixtures.

FIG. 5B shows tensile index values for specific fiber mixtures.

FIG. 5C shows strain at break values for specific fiber mixtures.

### Example 5

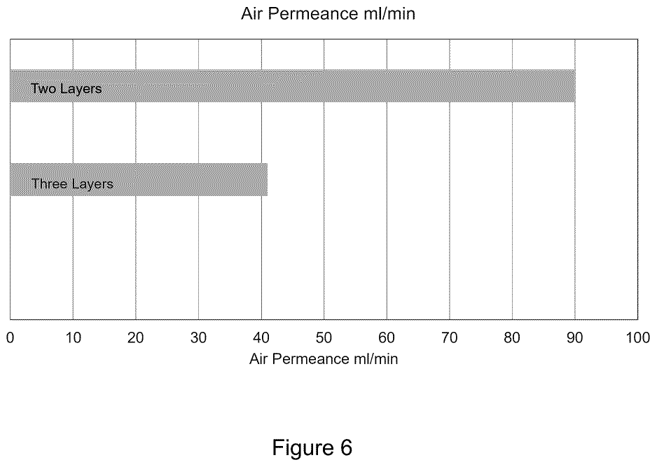

Multilayered sheets were produced as a combination of two or three layers by combining base conifer layer with Pulp 1 in different combinations. For instance, two layered sheets were produced by layering conifer base layer with Pulp 1 layer. For three layers the Pulp 1 layer was sandwiched between two conifer layers. The air permeances of resulting multilayered structures were measured based on ISO 5636-3 and are shown in FIG. 6.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A process, a product, or a use disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A multilayer product comprising:
a cellulose fiber-based base layer;
a barrier layer; and
a cellulosic filmic layer,
wherein the barrier layer comprises at least 10% (w/w) of hydrolysed cellulose fibers.

2. A multilayer product according to claim 1, wherein the cellulosic filmic layer is formed by coagulating alkaline cellulose dope.

3. The multilayer product according to claim 1, wherein the base layer and the barrier layer are both formed of cellulose-based materials.

4. The multilayer product according to claim 1, wherein the multilayer product is a packaging material, a packaging paper, a wrapping paper, a protective paper, a packaging board, a packaging 3D material, a decorative paper, an envelope, or a release liner.

5. The multilayer product according to claim 1, wherein the multilayer product is mainly formed of cellulose-based materials.

6. The multilayer product according to claim 1, wherein the multilayer product is biodegradable as determined by the standard OECD for testing of chemicals 301 F.

7. The multilayer product according to claim 1, wherein the hydrolysed cellulose fibers have a CED viscosity in the range of 50 to 500 ml/g.

8. The multilayer product according to claim 1, wherein the multilayer product further comprises a surface chemical for providing barrier properties applied to the multilayer product.

9. The multilayer product according to claim 1, wherein the multilayer product further comprises an adhesive layer between the base layer and the barrier layer.

10. The multilayer product according to claim 1, wherein the base layer is formed of a densified cellulose fiber mixture.

11. The multilayer product according to claim 1, wherein the base layer has a weight in the range of 20-800 gsm.

12. The multilayer product according to claim 1, wherein the barrier layer has a thickness of 300 μm or less.

13. The multilayer product according to claim 1, wherein the multilayer product does not comprise any plastic or metal.

14. The multilayer product according to claim 1, wherein the multilayer product has an oxygen transmission rate of 100 cm³ /(m².day) or less,

15. The multilayer product according to claim 1, wherein the water vapor permeability of the multilayer product is 500 g/(m² .day) or less.

16. The multilayer product according to claim 1, wherein the multilayer product has a heptane vapor transmission rate of 50 g/(m² .day) or less,

17. A method for producing a multilayer product, the method comprising;
forming a cellulose fiber-based base layer and a barrier layer;
forming the multilayer product from the base layer and the barrier layer; and
forming a cellulosic filmic layer,
wherein the barrier layer comprises at least 10% (w/w) of hydrolysed cellulose fibers.

18. The method according to claim 17, wherein the cellulosic filmic layer is formed by coagulating alkaline cellulose dope.

19. The method according to claim 17, wherein the forming the barrier layer includes forming material of the barrier layer comprising the hydrolysed cellulose fibers into a web and calendering the web, the method further comprising applying the barrier layer on the base layer.

20. The method according to claim 19, further comprising applying an adhesive layer between the base layer and the barrier layer.

21. The method according to claim 17, wherein the base layer and the barrier layer are formed simultaneously.

22. The multilayer product according to claim 10, wherein the densified cellulose fiber mixture comprises at least 50% (w/w) of Kraft pulp and/or mechanical pulp and 50% (w/w) or less of hydrolysed cellulose fibers.
